(19) United States
(12) Patent Application Publication
(10) Pub. No.: US 2008/0198345 A1
(43) Pub. Date: Aug. 21, 2008

(54) EXPOSURE APPARATUS AND METHOD OF MANUFACTURING DEVICE

(75) Inventors: Youji Kawasaki, Utsunomiya-shi (JP); Yoshio Kawanobe, Utsunomiya-shi (JP); Hitoshi Nakano, Utsunomiya-shi (JP); Mikio Arakawa, Utsunomiya-shi (JP); Takahito Chibana, Utsunomiya-shi (JP); Yoichi Matsuoka, Shioya-gun (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 12/026,590

(22) Filed: Feb. 6, 2008

(30) Foreign Application Priority Data
Feb. 16, 2007 (JP) 2007-036810

(51) Int. Cl. G03B 27/52

(52) U.S. Cl. 355/30

(57) ABSTRACT

An exposure apparatus having a stage configured to hold a substrate and to be moved, and a projection optical system configured to project light from a reticle to the substrate held by the stage, and exposing the substrate to light via liquid filled in a gap between the substrate and a final surface of the projection optical system is disclosed. The apparatus comprises a first nozzle configured to supply liquid to the gap; a second nozzle configured to selectively perform recovery of liquid from the gap and supply of liquid to a gap between the stage and the final surface of the projection optical system; and a third nozzle configured to recover liquid supplied via at least the second nozzle.

### BACKGROUND OF THE INVENTION

1. Field of the Invention

The present invention relates to an exposure apparatus for exposing a substrate held by a stage to light via a liquid filled in the gap between the substrate and the final surface of a projection optical system, and a method of manufacturing a device.

2. Description of the Related Art

An exposure apparatus for manufacturing a device such as a semiconductor device is constantly required to improve the resolving power. To improve the resolving power of the exposure apparatus, the NA of a projection optical system is increasing and the wavelength of exposure light is shortening. The wavelength of the exposure light is shifting from the 365-nm i-line to a KrF excimer laser wavelength of 248 nm and, recently, to an ArF excimer laser wavelength of 193 nm.

An immersion exposure scheme is currently receiving a great deal of attention as a technique for further improving the resolving power (PCT(WO) 99/49504). One of exposure apparatuses of the immersion exposure scheme is the one which exposes a substrate to light while the space between the substrate on a substrate stage and at least part of the final surface of a projection optical system is filled with a liquid. This exposure apparatus supplies the liquid to the space from a supply nozzle arranged at the periphery of the projection optical system, and recovers the liquid from the space via a recovery nozzle arranged at the periphery of the projection optical system.

In the exposure apparatus of the immersion exposure scheme as described above, for example, a foreign particle (foreign substance) on the substrate or substrate stage can adhere on the recovery nozzle because it flows into the recovery nozzle together with the liquid. In, e.g., exposing the substrate, this foreign particle can shield the exposure beam upon separating from the recovery nozzle, or adhere on, e.g., the substrate or the final surface of the projection optical system again. A foreign particle adhering on the substrate can cause a random failure, and that adhering on the final surface of the projection optical system again can cause a failure common to a plurality of shot regions or a plurality of substrates.

### SUMMARY OF THE INVENTION

The present invention has been made in consideration of the above-described background, and has as its exemplary object to provide an exposure apparatus having a function of reducing foreign particles that have an influence on exposure.

According to one aspect of the present invention, an exposure apparatus having a stage configured to hold a substrate and to be moved, and a projection optical system configured to project light from a reticle to the substrate held by the stage, and exposing the substrate to light via liquid filled in a gap between the substrate and a final surface of the projection optical system, the apparatus comprises:

a first nozzle configured to supply liquid to the gap;

a second nozzle configured to selectively perform recovery of liquid from the gap and supply of liquid to a gap between the stage and the final surface of the projection optical system; and

a third nozzle configured to recover liquid supplied via at least the second nozzle.

Further features of the present invention will become apparent from the following description of exemplary embodiments with reference to the attached drawings.

### BRIEF DESCRIPTION OF THE DRAWINGS

FIG. 1 is a view exemplifying the schematic arrangement of an exposure apparatus and a flow of a liquid in a first mode according to a preferred embodiment of the present invention;

FIG. 2 is a view exemplifying a flow of the liquid in a second mode;

FIG. 3 is a view exemplifying another flow of the liquid in the second mode;

FIG. 4 is a flowchart illustrating the overall sequence of a process of manufacturing a semiconductor device; and

FIG. 5 is a flowchart illustrating details of the wafer process.

### DESCRIPTION OF THE EMBODIMENT

A preferred embodiment of the present invention will be described below with reference to the accompanying drawings.

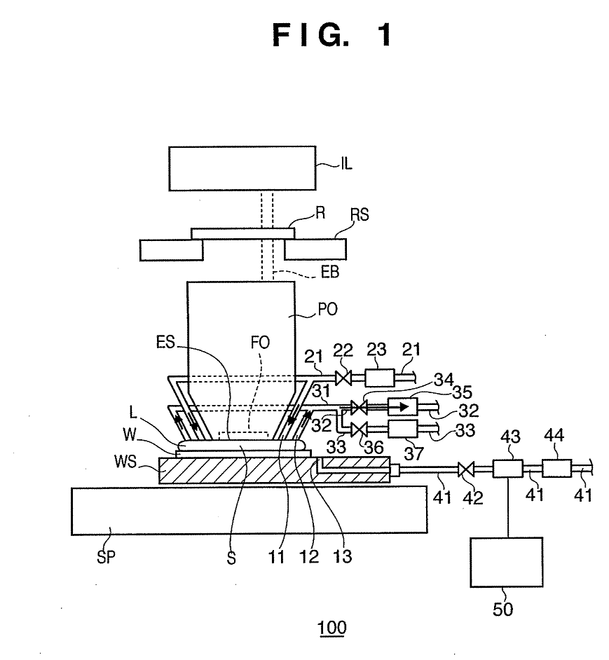

FIG. 1 is a view exemplifying the schematic arrangement of an exposure apparatus according to a preferred embodiment of the present invention. An exposure apparatus 100 shown in FIG. 1 comprises a reticle stage RS which holds a reticle R, an illumination optical system IL which illuminates the reticle R, a substrate stage WS which holds a substrate W, and a projection optical system PO which projects light or radiant energy from the reticle R, that contains the pattern information of the reticle R, to the substrate W. The exposure apparatus 100 can be, e.g., an exposure apparatus which scan-exposes the substrate W with an exposure beam EB shaped by a slit, while scan-driving the reticle R and substrate W, or an exposure apparatus which exposes the substrate W with the exposure beam EB while the reticle R and substrate W are at rest. The substrate stage WS has a substrate chuck (not shown) which holds the substrate W, and holds and moves the substrate W via the substrate chuck. The substrate stage WS can be driven on a stage support SP in, e.g., six axial directions.

The exposure apparatus 100 exposes the substrate W to radiant energy while a space (gap) S between the substrate W on the substrate stage WS and at least part of a final surface ES of the projection optical system PO is filled with a liquid L. The at least part of the final surface ES of the projection optical system PO includes the optical path of the exposure beam EB. The final surface ES of the projection optical system PO means a surface facing the substrate stage WS or substrate W, of the two surfaces of an optical element (final optical element) FO that is nearest to the substrate stage WS or substrate W of a plurality of optical members of the projection optical system PO. The exposure apparatus 100 exposes the substrate W to the radiant energy via the liquid filled in the space (gap) S between the final surface ES of the projection optical system PO and the substrate W held by the substrate stage WS.

To control the liquid, the exposure apparatus 100 has the following arrangement. That is, the exposure apparatus 100 also comprises a first nozzle 11, second nozzle 12, and third nozzle 13. The first nozzle 11 is arranged around the projection optical system PO, and supplies the liquid L to be filled in the space (gap) S to it. The first nozzle 11 may discharge the liquid toward the space S, or the liquid discharged from the first nozzle 11 may be allowed to migrate so as to fill the space S. The second nozzle 12 is arranged around the projection optical system PO. The second nozzle 12 recovers the liquid L from the space S in a first mode, while it supplies a liquid onto the substrate stage WS or to the space S in a second mode. That is, the second nozzle 12 is used to selectively recover the liquid from the space S and supply a liquid to the space S between the substrate stage WS and the final surface ES of the projection optical system PO. In the second mode, the third nozzle 13 recovers the liquid supplied to the space S. The liquid recovered by the third nozzle 13 includes at least the liquid supplied to the space S via the second nozzle 12. The third nozzle 13 may be used to recover the liquid even in the first mode.

The first mode includes an exposure mode of exposing the substrate W with the exposure beam EB and may include other modes. The second mode includes a cleaning mode of reducing foreign particles that have an influence on exposure, and may include other modes. This specification defines specific liquid supply methods as the first and second modes.

The first nozzle 11 is typically closer to the projection optical system PO than the second nozzle 12. According to one embodiment, each of the first nozzle 11 and second nozzle 12 can have a ring shape. According to another embodiment, each of the first nozzle 11 and second nozzle 12 can have a linear shape.

The first nozzle 11 communicates with one end of a liquid line (liquid supply line) 21 to which a valve 22 and pump 23 are attached. A control unit 50 controls the operation of the pump 23 and the opening/closing and/or degree of opening of the valve 22. The other end of the liquid line 21 connects to a liquid supply source (e.g., a supply tank).

The second nozzle 12 communicates with a liquid line 31. The liquid line 31 branches into a liquid line (liquid recovery line) 32 and liquid line (liquid supply line) 33. A valve 34 and pump 35 are attached to the liquid line 32. The control unit 50 controls the operation of the pump 35 and the opening/closing and/or degree of opening of the valve 34. The liquid line 32 connects to a liquid recovery unit (e.g., a recovery tank). A valve 36 and pump 37 are attached to the liquid line 33. The control unit 50 controls the operation of the pump 37 and the opening/closing and/or degree of opening of the valve 36. The liquid line 33 connects to a liquid supply source (e.g., a supply tank). The liquid lines 21 and 33 may connect to a common supply source.

The third nozzle 13 can be arranged on the substrate stage WS. The third nozzle 13 communicates with one end of a liquid line (liquid recovery line) 41 to which a valve 42, foreign particle inspection unit (detector) 43, and pump 44 are attached. The control unit 50 controls the operations of the foreign particle inspection unit 43 and pump 44 and the opening/closing and/or degree of opening of the valve 42. The other end of the liquid line 41 connects to a liquid recovery unit (e.g., a recovery tank). The liquid line 41 can be partially formed by a flexible tube so as to move the substrate stage WS.

The foreign particle inspection unit 43 inspects the liquid recovered via the third nozzle 13 for a foreign particle. For example, the foreign particle inspection unit 43 irradiates the liquid with light and detects a foreign particle on the basis of the intensity of the light scattered by the liquid. The output from the foreign particle inspection unit 43, i.e., the inspection result obtained by it is sent to the control unit 50.

The control unit 50 controls the valve 22 and pump 23 so as to supply the liquid to the space S via the first nozzle 11 in the first mode. The control unit 50 also controls the valves 34 and 36 and pumps 35 and 37 so as to recover the liquid L from the space S via the second nozzle 12 in the first mode and to supply a liquid onto the substrate stage WS or to the space S via the second nozzle 12 in the second mode. The control unit 50 also controls the valve 42 and pump 44 so as to recover the liquid on the substrate stage WS via the third nozzle 13 in the second mode.

FIG. 1 exemplifies a flow of the liquid in the first mode. In the first mode (exposure mode), the exposure apparatus 100 exposes the substrate W to radiant energy while the space S between the substrate W on the substrate stage WS and at least part of the final surface ES of the projection optical system PO is filled with the liquid L. The control unit 50 controls the valve 22 and pump 23 so as to discharge the liquid via the first nozzle 11, while it controls the valve 34 and pump 35 so as to recover the liquid L from the space S via the second nozzle 12. Under this control, the liquid L is continuously exchanged during the exposure of the substrate W.

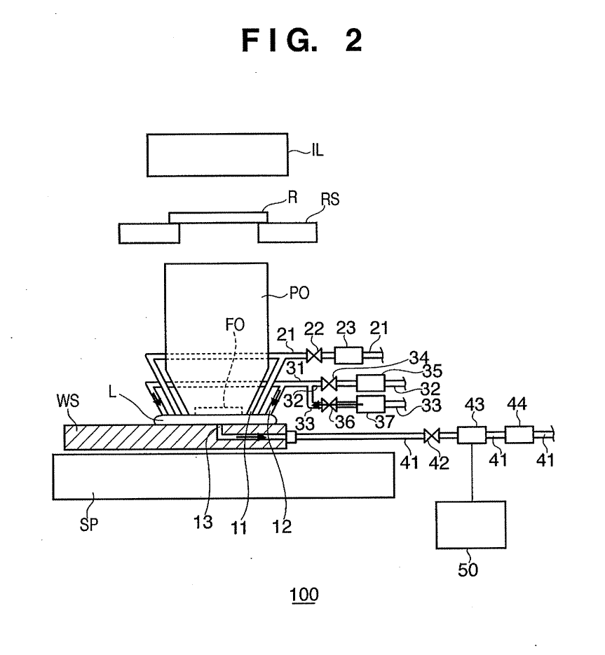

FIG. 2 shows an example of a flow of the liquid in the second mode. In the second mode (cleaning mode), the control unit 50 controls the valves 34 and 36 and pumps 35 and 37 so as to supply a liquid (cleaning liquid) onto the substrate stage WS or to the space S from the second nozzle 12. Also in the second mode, the control unit 50 controls the valve 42 and pump 44 so as to recover the liquid from the substrate stage WS via the third nozzle 13. Under this control, a foreign particle adhering on the second nozzle 12 can be recovered via the third nozzle 13 upon separating from the second nozzle 12 and migrating together with the liquid. In addition to the foreign particle adhering on the second nozzle 12, foreign particles adhering on other members (e.g., the projection optical system PO and substrate stage WS) can be recovered via the third nozzle 13 upon being trapped by the liquid stream and then separating from the other members.

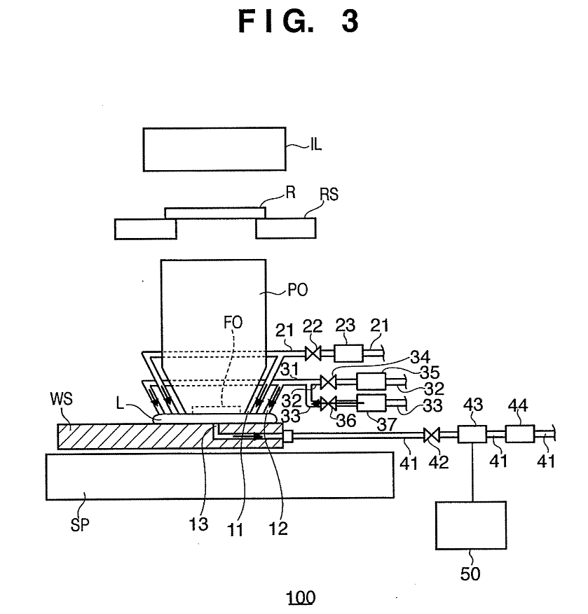

FIG. 3 shows another example of the flow of the liquid in the second mode. In the second mode (cleaning mode) of this example, the control unit 50 controls the valves 22, 34, and 36 and pumps 23, 35, and 37 so as to supply the liquid to the space S via the first nozzle 11 parallel to the supply of the liquid to the space S via the second nozzle 12. The control unit 50 also controls the valve 42 and pump 44 so as to recover the liquid on the substrate stage WS via the third nozzle 13. Under this control, a foreign particle adhering on the second nozzle 12 can be recovered via the third nozzle 13 upon separating from the second nozzle 12 and migrating together with the liquid. In this example, the foreign particle separated from the second nozzle 12 is suppressed from adhering on the first nozzle 11 at the same time.

In the second mode, the control unit 50 controls the liquid flowing through the second nozzle 12 and third nozzle 13, on the basis of the inspection result obtained by the foreign particle inspection unit 43. As exemplified in FIG. 3, when the liquid is discharged via the first nozzle 11 in the second mode, the control unit 50 controls the liquid flowing through the first nozzle 11, second nozzle 12, and third nozzle 13, on the basis of the inspection result obtained by the foreign particle inspection unit 43.

As exemplified in FIGS. 2 and 3, the second mode is typically executed by aligning the substrate stage WS such that the third nozzle 13 falls within an area surrounded by the second nozzle 12.

In the second mode, the control unit 50 preferably controls the liquid so as to discharge a liquid from the second nozzle 12 and to recover the liquid via the third nozzle 13 until the amount of foreign particles detected by the foreign particle inspection unit 43 becomes lower than a prescribed level. As described above, the liquid is controlled by controlling the valves and pumps. The substrate stage WS preferably does not hold the substrate W in the second mode so as to prevent a foreign particle from adhering on the substrate W. In this case, the substrate stage WS may hold a cleaning substrate (dummy substrate) in place of the substrate W.

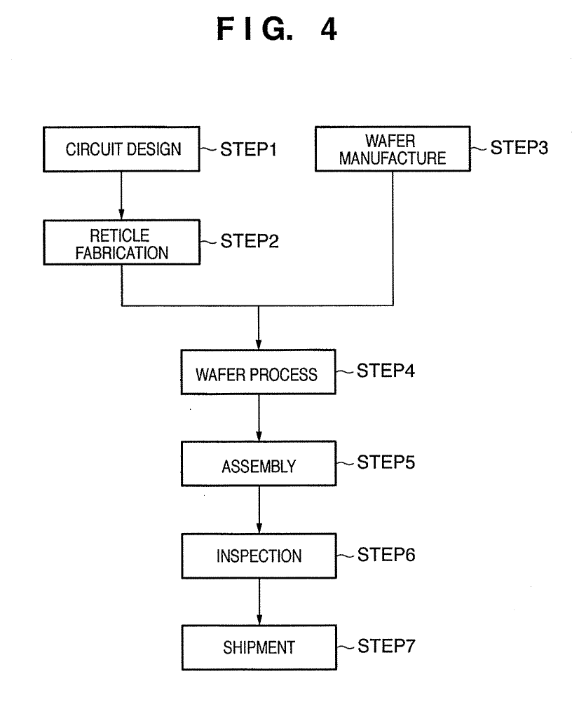

A method of manufacturing a device using the above-described exposure apparatus will be explained next. FIG. 4 is a flowchart illustrating the overall sequence of a process of manufacturing a semiconductor device. In step 1 (circuit design), the circuit of a semiconductor device is designed. In step 2 (reticle fabrication), a reticle (also called an original or mask) is fabricated on the basis of the designed circuit pattern. In step 3 (wafer manufacture), a wafer (also called a substrate) is manufactured using a material such as silicon. In step 4 (wafer process) called a preprocess, an actual circuit is formed on the wafer by lithography using the reticle and wafer. In step 5 (assembly) called a post-process, a semiconductor chip is formed using the wafer manufactured in step 4. This step includes processes such as assembly (dicing and bonding) and packaging (chip encapsulation). In step 6 (inspection), inspections including operation check test and durability test of the semiconductor device manufactured in step 5 are performed. A semiconductor device is completed with these processes and shipped in step 7.

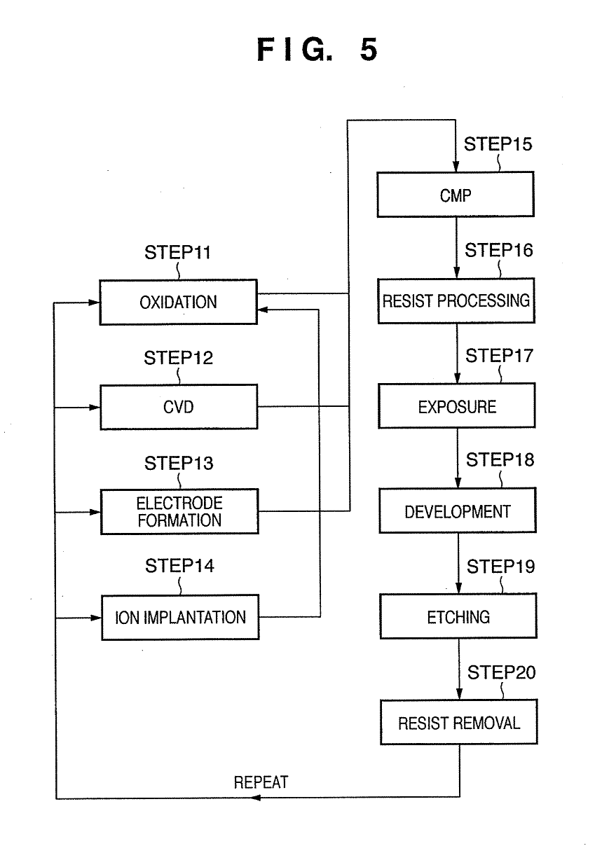

FIG. 5 is a flowchart illustrating details of the wafer process. In step 11 (oxidation), the wafer surface is oxidized. In step 12 (CVD), an insulating film is formed on the wafer surface. In step 13 (electrode formation), an electrode is formed on the wafer by vapor deposition. In step 14 (ion implantation), ions are implanted into the wafer. In step 15 (CMP), the insulating film is planarized by CMP. In step 16 (resist processing), a photosensitive agent is applied on the wafer. In step 17 (exposure), the above-described exposure apparatus is used to form a latent image pattern on the resist by exposing the wafer coated with the photosensitive agent to radiant energy via the mask on which the circuit pattern is formed. In step 18 (development), the latent image pattern formed on the resist on the wafer is developed to form a resist pattern. In step 19 (etching), the layer or substrate under the resist pattern is etched through an opening of the resist pattern. In step 20 (resist removal), any unnecessary resist remaining after etching is removed. By repeating these steps, a multilayered structure of circuit patterns is formed on the wafer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-036810, filed Feb. 16, 2007, which is hereby incorporated by reference herein in its entirety.

What is claimed is:

1. An exposure apparatus having a stage configured to hold a substrate and to be moved, and a projection optical system configured to project light from a reticle to the substrate held by the stage, and exposing the substrate to light via liquid filled in a gap between the substrate and a final surface of the projection optical system, the apparatus comprising:
a first nozzle configured to supply liquid to the gap;
a second nozzle configured to selectively perform recovery of liquid from the gap and supply of liquid to a gap between the stage and the final surface of the projection optical system; and
a third nozzle configured to recover liquid supplied via at least the second nozzle.

2. An apparatus according to claim 1, wherein the third nozzle is arranged on the stage.

3. An apparatus according to claim 1, wherein the first nozzle and the second nozzle are arranged around a final optical element of the projection optical system.

4. An apparatus according to claim 1, further comprising a detector configured to detect a foreign particle in liquid recovered via the third nozzle,
wherein the apparatus is configured so that liquid is supplied via the second nozzle and liquid is recovered via the third nozzle based on output from the detector.

5. An apparatus according to claim 4, wherein the apparatus is configured so that liquid is supplied via the second nozzle and liquid is recovered via the third nozzle until an amount of foreign particles detected by the detector becomes less than a predetermined level.

6. An apparatus according to claim 4, wherein the detector is configured to irradiate liquid with light and to detect a foreign particle based on light scattered by the liquid.

7. An apparatus according to claim 1, wherein the apparatus is configured so that liquid is supplied via the first nozzle parallel to supply of liquid via the second nozzle.

8. An apparatus according to claim 1, wherein the apparatus is configured so that a cleaning liquid is supplied via the second nozzle.

9. A method of manufacturing a device, the method comprising:
exposing a substrate to light using an exposure apparatus defined in claim 1;
developing the exposed substrate; and
rocessing the developed substrate to manufacture ice.
